(19) United States
(12) Patent Application Publication
(10) Pub. No.: US 2012/0137671 A1
(43) Pub. Date: Jun. 7, 2012

(54) STIRLING ENGINE ARRANGEMENT

(76) Inventor: Günther Schliebe, Esslingen (DE)

(21) Appl. No.: 13/321,916

(22) PCT Filed: May 19, 2010
(86) PCT No.: PCT/EP10/03055

§ 371 Date: Feb. 13, 2012

(30) Foreign Application Priority Data
May 28, 2009 (DE) 10 2009 023 024.6

(51) Int. Cl. F02G 1/044

(52) U.S. Cl. 60/525

(57) ABSTRACT

A Stirling engine arrangement is provided, with a base body to which a plurality of piston pairs are allocated, each with a working piston and a displacement piston; and with a gear device arranged on the base body for coupling the linearly mobile working pistons with a rotatably mounted output shaft, the rotation axis of which is aligned transverse to the movement direction of the piston pairs. The gear device is formed as a planetary gear in which a plurality of planet wheels are arranged rotatably on a sun wheel coupled to the output shaft and formed for rolling motion on a crown wheel surrounding the sun wheel, wherein the planet wheels are arranged on planet shafts aligned parallel to each other and parallel to the output shaft, which each carry a cam device formed to rest on the allocated working piston.

The invention concerns a Stirling engine arrangement with a base body to which a plurality of piston pairs are allocated which each comprises a working piston and a displacement piston, wherein the working piston is held linearly mobile in a cylinder and with the cylinder determines a variable volume working chamber, and the displacement piston is held linearly mobile in a cylinder and with the cylinder determines a variable volume displacement chamber which is connected in a communicating manner with the working chamber, wherein centre axes of adjacent cylinders enclose an acute angle; and with a gear device arranged on the base body for coupling the linearly mobile working piston with a rotatably mounted output shaft, the rotation axis of which is aligned transverse to the movement direction of the piston pairs.

Using such a Stirling engine arrangement, thermal energy provided in the form of heat energy can be converted with high efficiency into kinetic energy, for example to drive an electric generator. To operate the Stirling engine arrangement only a temperature difference is required, for example between the temperature of a heat transfer fluid and the temperature of a cooling fluid, to generate kinetic energy: the thermal energy can for example be provided by combustion of a primary energy carrier or by solar energy or geothermal energy.

For advantageous efficiency of the conversion of thermal energy into kinetic energy, the arrangement of the working piston and displacement piston and their kinematic linking with an output shaft are important. Usually the Stirling engine arrangement is used for conversion of the linear motion of the working piston into a rotary motion of an output shaft.

In a Stirling star motor known from DE 10 2004 059 928 A1, the linear motion is transferred between the radially arranged, outwardly aligned working piston and a rotatably mounted, multiply bent crankshaft by means of connecting rods mounted mobile on the working piston and on the crankshaft. Here the rotational relative movements of the connecting rods in relation to the working piston and the crankshaft cause certain friction losses which reduce the overall efficiency of the known Stirling engine arrangement.

DE 196 16 256 A1 discloses a Stirling engine gearing in which the linear motion of the working piston is converted into a rotary motion of the output shaft by means of a double cam plate. Both a working piston connecting rod and a displacement piston connecting rod act on the double cam plate. In this arrangement too, friction-induced losses occur due to the swivel movements between the working piston, displacement piston, allocated connecting rods and the output shaft.

The object of the invention is to provide a Stirling engine arrangement which allows conversion of the linear motion of the working piston into the rotary motion of the output shaft with high efficiency.

This object is achieved for a Stirling engine arrangement of the type cited initially with the features of claim 1. It is provided that the gear device is formed as a planetary gear in which a plurality of planet wheels are arranged rotatable on a sun wheel coupled to the output shaft and are formed for a rolling motion on a crown wheel surrounding the sun wheel, wherein the planet wheels are arranged on parallel planet shafts, aligned parallel to the output shaft, which each carry a cam device which is formed to support an allocated working piston, which cam devices are formed to convert a linear motion of the working piston into a rotary motion of the allocated planet shaft and the sun wheel coupled thereto.

The planet wheels, associated cam devices, the sun wheel and the crown wheel are matched to each other such that a relative movement between the working piston and cam device takes place as a roll movement, preferably slip-free. The design of the force transfer between the working piston and cam device as a roll movement ensures a high efficiency between the force provided by the working piston and the consequent torque applied to the output shaft. Relative movements with friction in the transfer of the force from the working piston to the output shaft, as occur with piston/connecting rod arrangements mounted to swivel in relation to each other, can be almost completely avoided with a suitable design of the working piston and the cam devices. Preferably the cam device is formed such that in the context of the planet movement about the sun wheel, which entails an overlaying of two rotational motions, it provokes a substantially sine wave-like movement of the working piston. Where applicable by suitable modification of the geometry of the cam device, a deviation from a sine wave-like movement of the working piston in areas can be provoked in order to increase the efficiency of the Stirling cyclic process. This possibility of changing the movement of the working piston by adapting the geometry of the cam device, as well as the friction reduction, is a further advantage of the Stirling engine arrangement according to the invention in comparison with coupling of the working piston and the output shaft by means of connecting rods, which does not allow such movement adaptation.

Due to the design of the gear device as a planetary gear in which the planet shafts are arranged circulating in the crown wheel, the desired rolling motion between the working piston and cam device can be achieved advantageously, preferably with a Stirling engine arrangement fitted with a plurality of piston pairs. Also the force effect of the working piston on the allocated cam device and the rotational relative movement between the planet wheels and the sun wheel coupled to the output shaft, cause a reduction ratio in the movement of the drive pistons. Thus the Stirling engine arrangement can be used for different applications directly without subsequent reduction gears which reduce efficiency.

Advantageous refinements of the invention are given in the sub-claims.

It is expedient if the planet shafts are rotatably mounted at an even angular pitch on the periphery of the sun wheel and each carry a planet wheel which is formed on a peripheral area, in particular on the outer periphery, for toothed engagement in the crown wheel. By arranging the planet shafts at an even angular pitch on the periphery of the sun wheel, it is ensured that the movements of the working pistons, arranged preferably in star shape with even angular pitch, can be transferred to the output shaft in a synchronised manner. The rotatable mounting of the planet shafts on the periphery of the sun wheel can be achieved by means of suitable bearing means, for example ball or needle roller bearings. Alternatively the sun wheel has external peripheral toothing which is arranged opposite the internal toothing of the crown wheel. Here the planet wheels bridge a ring gap formed between the sun wheel and crown wheel and thus engage both in the toothing of the sun wheel and in the toothing of the crown wheel for force transfer.

In one embodiment of the invention it is provided that in the communicating connection between the working chamber and the displacement chamber, which is formed in particular as a pipeline, a regenerator device for temporary storage of thermal energy is connected in a communicating manner. The regenerator device has the task of temporarily storing the thermal energy contained in the fluid displaced by the working piston and emitting the heat to the fluid again on a fluid flow from the displacement piston to the working piston, whereby better efficiency of the Stirling engine arrangement can be achieved.

Preferably centre axes of the working pistons are arranged in a common working piston plane, which is aligned transverse to the rotation axis of the output shaft, and centre axes of the displacement pistons are arranged in a common displacement piston plane, which is arranged parallel to and spaced from the working piston plane. Thus the linear movements of the working pistons take place in a first plane while the linear movements of the displacement pistons take place in a second plane arranged parallel to and spaced from the first plane. This physical separation between the working pistons and the displacement pistons allows an advantageous supply of heat to the working pistons and an advantageous dissipation of heat from the displacement pistons.

It is advantageous if each planet shaft carries a first cam device allocated to the working piston and a second cam device arranged spaced therefrom along the rotation axis and allocated to the displacement piston, wherein the cam devices are formed, at least in areas, for movement coupling between the working piston and the displacement piston of a piston group. The cam device for the working piston firstly has the task of moving the working piston from a bottom dead centre position in the direction of a top dead centre position of the linear motion, and secondly starting from the top dead centre position, transferring to the output shaft the work occurring on expansion of the fluid oscillating between the working piston and displacement piston. The cam device for the displacement piston has the task of displacing the fluid temporarily present in the displacement chamber in the direction of the working chamber by corresponding movement of the displacement piston. It is expedient if the working pistons and/or the displacement pistons are arranged at an even angular pitch about the sun wheel. This facilitates synchronisation of the movement of the gear device between the individual piston pairs. It is particularly advantageous if the number, arrangement and cycle times for the piston pairs are selected such that a substantially constant torque is always exerted on the output shaft of the Stirling engine arrangement.

In an advantageous embodiment of the invention, the working piston of a piston pair is held in a working cylinder, which is formed as a unilaterally closed sleeve and held in areas in the base body. Preferably the working cylinder is mounted interchangeably on the base body so that in case of repair a simple exchange of individual working cylinders can be made. Both the base body and the working cylinder can be formed as simple components which can be produced at low production cost. Preferably the working cylinder with a corresponding thread device is screwed directly into the base body or connected fixedly and detachably with the base body via a separate holding device.

In a refinement of the invention it is provided that a section of the working cylinder protruding radially out over the base body is held in a housing through which fluid can flow and/or that a flow channel for a fluid passes through the base body in the area of the working cylinder. For efficient heat transport to the working cylinders, a fluid chamber is provided which surrounds the base body in parts, in particular sealing, and into which project the working cylinders. A fluid serving as a heat transfer medium flows through the fluid chamber, for example liquid or hot steam or hot gas which is heated from a heat source and emits the heat to the working cylinder. Preferably all working cylinders of the Stirling engine arrangement are held in the same fluid chamber, whereby an even and hence efficient heat supply to the working cylinders can be guaranteed.

It is expedient if the displacement piston of a piston pair is held in a displacement cylinder formed as a unilaterally closed sleeve and held in areas in the base body.

In a further embodiment of the invention a section of the displacement cylinder protruding radially outward over the base body is held in a housing through which fluid can flow and/or a flow channel for a fluid passes through the base body in the area of the displacement cylinder. This forms a fluid chamber for a cooling fluid, for example a cooling liquid or a cooling gas. The cooling fluid allows effective cooling of the outer skin of the displacement cylinder and hence an efficient dissipation of heat from the working fluid which oscillates between the working chamber and the displacement chamber.

It is expedient if a centre axis of a displacement cylinder encloses an acute angle with the centre axis of the allocated working cylinder. Thus advantageously the phase shift necessary for oscillating fluid exchange between the working chamber and displacement chamber, for the linear movements of the working piston and displacement piston, is achieved by means of the cam devices arranged on the planet shaft.

Preferably the base body has a first base body section to hold the working cylinder and a second base body section arranged adjacent along the rotation axis, wherein an isolation gap, preferably filled with isolation material, is formed between the first and second base body sections. Such a separation of the base body into two base body sections can prevent an undesirable heat transfer between the working cylinders and the displacement cylinders. This increases the efficiency of the Stirling engine arrangement. It is particularly advantageous if the isolation gap between the base body sections is filled with an isolation material which also prevents a radiant heat transmission between the two base body sections.

In an alternative embodiment of the invention it is provided that centre axes of the working pistons and centre axes of the displacement pistons are arranged in a common movement plane, which is aligned transverse to a rotation axis of the output shaft. This achieves a Stirling engine arrangement with a small extent along the rotation axis as all pistons are arranged in the same movement plane.

As a further embodiment of the invention, adjacent piston pairs lie with the working pistons or the displacement pistons adjacent to each other. Thus an advantageous heat supply to the working pistons and/or advantageous heat dissipation from the displacement pistons can be achieved, as in each case two pistons of the same type can be enclosed by a common fluid chamber.

An advantageous embodiment of the invention is shown in the drawing. This shows:

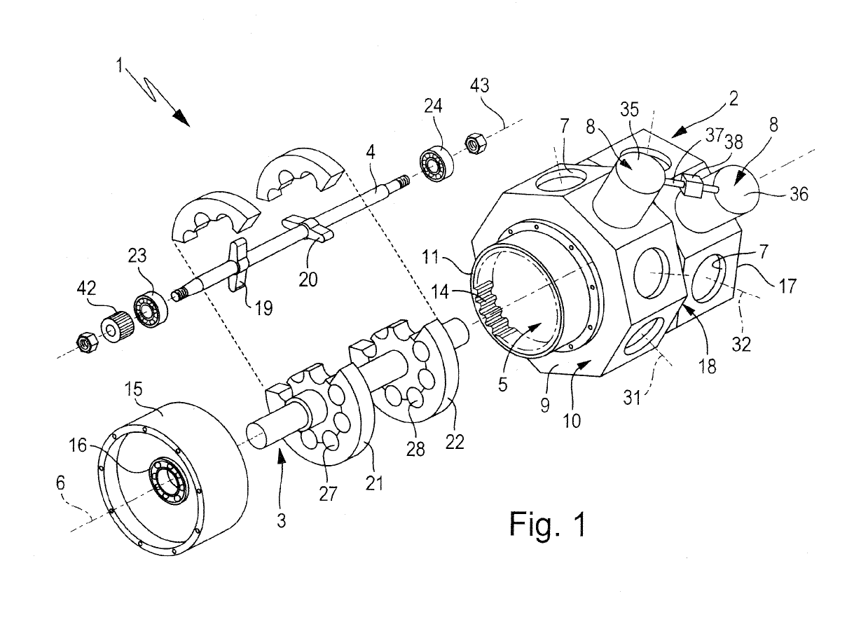

FIG. 1 a perspective exploded view of a Stirling engine arrangement,

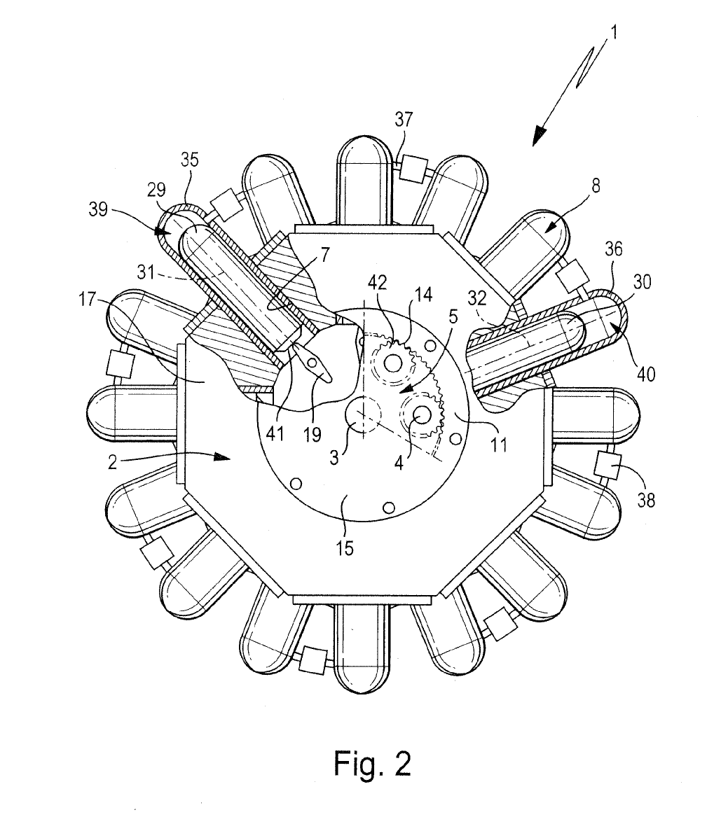

FIG. 2 a front view of the Stirling engine arrangement according to FIG. 1,

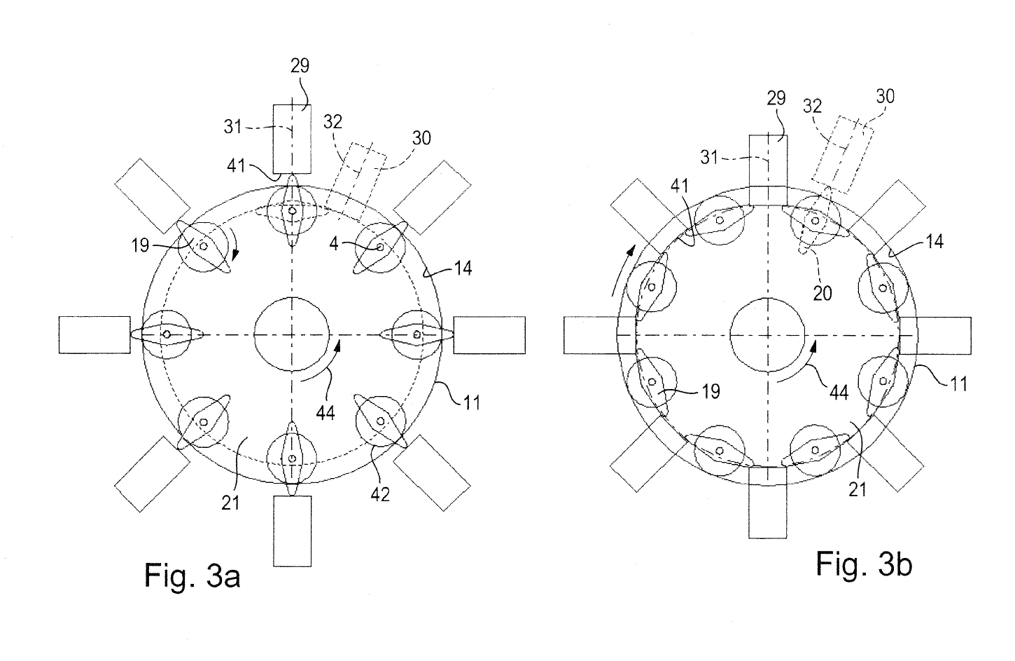

FIG. 3a a diagrammatic view of a gear device of the Stirling engine arrangement in a first function position and

FIG. 3b the diagrammatic depiction of the gear device according to FIG. 3a in a second function position.

A Stirling engine arrangement 1 according to FIGS. 1 and 2 comprises a base body 2, shown as an example as a regular polygon and divided into two parts, an output shaft 3 and planet shafts 4 mounted rotatably on the output shaft 3.

Passing through the base body 2 is a gear recess 5 which is provided to hold the output shaft 3 and the planet shafts 4 mounted rotatably thereon and which extends along a centre axis 6 of the output shaft 3. Transverse to the centre axis 6 in the base body 2 are formed cylinder bores 7, extending radially at even pitch, which serve to hold cylinder sleeves 8 closed at the end. The cylinder bores 7 are arranged in two planes, spaced apart and not shown in detail, of the base body 2 formed by two base body sections 10, 18.

Starting from a face 9 of the first base body section 10, in the direction of the centre axis 6 extends a sleeve-like crown wheel 11 which has inner toothing 14. The crown wheel 11 is connected rotationally fixed with the first base body section 10. On its outer periphery it has a cylindrical surface which is intended to receive a rotationally symmetrical cup-shaped bearing plate 15 which is placed onto the crown wheel 11 and can be connected therewith to be rotationally fixed. The bearing plate 15 in a centrally arranged recess carries a rotary bearing 16, formed for example as a ball bearing, to support the output shaft 3.

On a face 17 of the second base body 18, facing away from face 9 of the first base body section 10, is mounted a rotary bearing not shown in detail and also for example formed as a ball bearing which forms the second bearing for the output shaft 3.

The planet shaft 4 carries two cam devices 19 and 20 spaced apart in the direction of the centre axis 6 and arranged rotationally fixed on the planet shaft 4 and aligned offset to each other for example by 90°. In the present embodiment the two cam devices 19, 20 have the same diamond-shaped cross section in a cross section plane aligned perpendicular to the centre axis 6.

Each of the planet shafts 4 is mounted rotationally mobile on two sun discs 21, 22, placed on the output shaft 3, by means of bearing devices 23, 24 formed for example as ball bearings. To hold these bearing devices 23, 24, the sun discs 21, 22 each have bearing recesses 27, 28 parallel to the centre axis 6 and aligned concentric to each other.

In the exemplary embodiment shown, in the first base body section 10 and in the second base body section 18 are formed eight cylinder bores 7. The Stirling engine arrangement 1 has in total eight working pistons 29 shown in detail in FIG. 2 and eight displacement pistons 30 which form eight piston pairs. All working pistons 29 are held in the same base body section 10 while all displacement pistons are held in the second base body section 18. The centre axes 31, shown as examples, of the working pistons 29 aligned vertical to the centre axis 6 of the base body 2 determine a first working piston plane not shown in detail. The centre axes 32 of the displacement pistons 30 aligned in the second base body section 18 vertical to the centre axis 6 determine a second displacement plane not shown in detail.

For greater clarity, FIG. 1 shows only one piston pair containing a working cylinder 35 with a working piston 29 held therein and shown in detail in FIG. 2, and a displacement cylinder 36 with a displacement piston 30 held therein and shown in detail in FIG. 2. Furthermore allocated to the piston pair is a connecting line 37 arranged between working cylinder 35 and displacement cylinder 36 and a regenerator 38 coupled communicating with the connecting line 37.

It can be seen from FIG. 2 that the working piston 29 and the working cylinder 35 delimit a working chamber 39 while the displacement piston 30 and the displacement cylinder 36 delimit a displacement chamber 40. The working chamber 39 and the displacement chamber 40 are connected together via the connecting line 37 in which the regenerator 38 is connected in communication. Thus via the connecting line 37, a fluid exchange can take place between the working chamber 39 and displacement chamber 40.

It is clear from FIG. 2 how a force transfer takes place between the working piston 29 and cam device 19. In FIG. 2 the working piston 29 is at the top dead centre and hence that the upper reversing point between the linear upward movement and the linear downward movement. In this state the radially inward facing end 41 lies on the apex of the diamond-shaped cam device 19. In the working chamber 39 because of the heat supply from a heat source not shown, an expansion of the enclosed working fluid occurs. As described in more detail below in relation to FIG. 3, at the same time an upward movement of the displacement piston 30 takes place, so the working fluid exerts a radially inwardly directed compressive force on the working piston 29 which is transferred via face 41 to the cam device 19. Because of the rotatable mounting of the planet shaft 4 coupled to the cam device 19, a torque is exerted on the planet shaft 4. The torque leads firstly to a rolling motion of the planet wheel 42 coupled to the planet shaft 4 on the inner toothing 14 of the crown wheel 11, whereby a movement occurs of the planet shaft 4 on an orbit about the centre axis 6. Secondly a rolling motion of the cam device 19 on the face 41 of the working piston 29 occurs. The consequent movement of the planet shaft 4 thus results from an overlaying of two rotation movements. A turning point of the first rotation movement lies on the centre axis 6 of the output shaft 3; a turning point of the second rotation movement lies on the centre axis 43 of the planet shaft 4.

The centre axes 31 of the working pistons 29 are arranged at an even angular pitch to each other; the same applies to the centre axes 32 of the displacement pistons 30. The centre axes 31, 32 of a piston pair of a working piston 29 and a displacement piston 30 enclose an acute angle in a projection plane, the surface normal of which is aligned parallel to the centre axis 6. Thus in combination with the offset arrangement of the cam devices 19 and 20 on the planet shaft 4, a coupling occurs between the starting movements for the working piston 29 and the displacement piston 30, which is advantageous for the Stirling process.

As the first base body section 10 can be surrounded by a first fluid housing not shown which, together with the first base body section 10 and the working cylinders 35, forms a closed fluid chamber through which can flow a heated thermal transfer fluid, for example a heating gas or heating fluid, to supply heat to the working cylinder 35. In the same way, the second base body section 18 can be tightly surrounded by a second fluid housing not shown which, together with the second base body section and the displacement cylinders, forms a second fluid chamber through which flows a cooling fluid, for example a cooling gas or cooling liquid. This guarantees the cooling of the displacement cylinders 36. The division of the base body 2 into two base body sections 10 and 18 creates an advantageous separation between the heated working cylinders and the cooled displacement cylinders, which can result in an advantageous efficiency for the Stirling engine arrangement.

FIGS. 3a and 3b show diagrammatically how cooperation between the working pistons 29 and the cam devices 19 on the planet shafts 4 can take place in interaction with the crown wheel 11 and the planet wheels 42. For simplification reasons, the depictions in FIGS. 3a and 3b show all working pistons 29 and displacement pistons 30 synchronised. Such a synchronisation of all working pistons 29 and displacement pistons 30 is not obligatory. Alternatively for example it can be provided that working pistons 29 or displacement pistons 30 arranged opposite each other can run in opposing directions.

It is clear from the depiction in FIG. 3a that the planet wheels 42 with their outer periphery each engage in the inner toothing 14, not shown in detail, of the diagrammatically indicated crown wheel 11 and are each mounted rotatable on the sun discs 21 of the output shaft 3 which serves as a sun wheel. As indicated in FIG. 3a by the rotation direction arrow 44, the output shaft 3 for example rotates counter-clockwise while the planet wheels 42, because of the rolling motion on the crown wheel 11, each rotate clockwise about the respective planet shaft 4. All working pistons 29 according to the depiction in FIG. 3a are arranged in the compression position in which the working chamber is at a minimum and in which, because of the heat supply to the working cylinder not shown, an expansion of the working fluid is directly impending. On this expansion of the working fluid, the working piston 29 is displaced radially inward and exerts a pressure on the cam device 19. The counter-clockwise rotation of the output shaft 3 and the associated clockwise rotation of the planet wheels 42 cause the cam devices 19 to roll on the faces 41 of the working piston 29. Thus starting from the position shown of the cam device 19, a lever arm is provided in relation to the planet shaft 4. The pressure of the working piston 29 acting on this lever arm causes a torque on the planet shaft 4 and its coupled planet wheel 42. This torque exerts a force acting in the circumferential direction on the sun disc 21 which results in a torque on the output shaft 3. The output shaft, because of this torque, continues its counter-clockwise motion.

As the rolling motion of the planet wheels 42 on the crown wheel 11 leads to a deflection movement of the cam device 19 in relation to the linearly mobile working piston 29, this can be moved inward in the radial direction. Thus a rolling motion of the cam device 19 takes place on the face 41 of the working piston 29 up to the position shown in FIG. 3b. In the position in FIG. 3b, the working piston 29 is at the bottom dead centre in which for a brief moment two cam devices 19 lie on the face 41. While the one cam device 19 then loses contact with the face 41, the other cam device 19 pushes the working piston 29 out of the bottom dead centre position shown, radially outward, in the direction of the top dead centre position as shown in FIG. 3a.

In the bottom dead centre position of working piston 29 according to FIG. 3b, the volume of the working chamber 39 is at a maximum. At the same time the displacement piston 30, shown in dotted lines only, because of the force effect of the cam device 20, also shown in dotted lines only, is moved to the top dead centre position in which the displacement chamber 40 has a maximum volume.

On further rotation of the output shaft 3 counter-clockwise, firstly the continued rotation of the planet wheel 42 clockwise moves the working piston 29 out of the bottom dead centre position towards the top dead centre position, so that the working fluid is shifted out of the working chamber to the displacement chamber. Because of the design of the cam device 20 shown in dotted lines and the clockwise rotation of the planet wheel 42, the displacement piston 30 is moved out of the top dead centre position towards the bottom dead centre position, whereby the displacement chamber is enlarged and the working fluid can be at least partly cooled in the displacement chamber.

In an embodiment of the invention not shown, the working piston and displacement piston are arranged concentrically in a common cylinder and for example controlled by different cam devices which are formed in movement planes spaced parallel to the centre axis and which in particular are directly adjacent to each other. This allows a particularly compact design of the Stirling engine arrangement.

1-15. (canceled)

16. Stirling engine arrangement with a base body to which a plurality of piston pairs are allocated which each comprise a working piston and a displacement piston, wherein the working piston is held linearly mobile in a cylinder and with the cylinder determines a variable volume working chamber, and the displacement piston is held linearly mobile in a cylinder and with the cylinder determines a variable volume displacement chamber which is connected in a communicating manner with the working chamber, wherein centre axes of adjacent cylinders enclose an acute angle; and with a gear device arranged on the base body for coupling the linearly mobile working piston with a rotatably mounted output shaft, the rotation axis of which is aligned transverse to the movement direction of the piston pairs, characterised in that the gear device is formed as a planetary gear in which a plurality of planet wheels are arranged rotatable on a sun wheel coupled to the output shaft and are formed for a rolling motion on a crown wheel surrounding the sun wheel, wherein the planet wheels are arranged on parallel planet shafts, aligned parallel to the output shaft, which each carry a cam device which is formed to support an allocated working piston, which cam devices are formed to convert a linear motion of the working piston into a rotary motion of the allocated planet shaft and the sun wheel coupled thereto.

17. Stirling engine arrangement according to claim 16, wherein the planet shafts are rotatably mounted at an even angular pitch on the periphery of the sun wheel and each carry a planet wheel which is formed on a peripheral area, in particular on the outer periphery, for toothed engagement in the crown wheel.

18. Stirling engine arrangement according to claim 16, wherein in the communicating connection between the working chamber and the displacement chamber, which is formed in particular as a pipeline, a regenerator device for temporary storage of thermal energy is connected in a communicating manner.

19. Stirling engine arrangement according to claim 16, wherein centre axes of the working pistons are arranged in a common working piston plane, which is aligned transverse to the rotation axis of the output shaft, and in that centre axes of the displacement pistons are arranged in a common displacement piston plane, which is arranged parallel to and spaced from the working piston plane.

20. Stirling engine arrangement according to claim 19, wherein each planet shaft carries a first cam device allocated to the working piston and a second cam device arranged spaced there from along the rotation axis and allocated to the displacement piston, wherein the cam devices are formed, at least in areas, for movement coupling between the working piston and the displacement piston of a piston group.

21. Stirling engine arrangement according to claim 16, wherein the working pistons and/or the displacement pistons are arranged at an even angular pitch about the sun wheel.

22. Stirling engine arrangement according to claim 16, wherein the working piston of a piston pair is held in a working cylinder, which is formed as a unilaterally closed sleeve and held in areas in the base body.

23. Stirling engine arrangement according to claim 22, wherein a section of the working cylinder protruding radially outward over the base body is held in a housing through which fluid can flow and/or in that a flow channel for a fluid passes through the base body in the area of the working cylinder.

24. Stirling engine arrangement according to claim 16, wherein the displacement piston of a piston pair is held in a displacement cylinder formed as a unilaterally closed sleeve and held in areas in the base body.

25. Stirling engine arrangement according to claim 24, wherein a section of the displacement cylinder protruding radially outward over the base body is held in a housing through which fluid can flow and/or in that a flow channel for a fluid passes through the base body in the area of the displacement cylinder.

26. Stirling engine arrangement according to claim 24, wherein a centre axis of a displacement cylinder encloses an acute angle with the centre axis of the allocated working cylinder.

27. Stirling engine arrangement according to claim 16, wherein the base body has a first base body section to hold the working cylinder and a second base body section arranged adjacent along the rotation axis, wherein an isolation gap, preferably filled with isolation material, is formed between the first and second base body sections.

28. Stirling engine arrangement according to claim 16, wherein centre axes of the working pistons and centre axes of the displacement pistons are arranged in a common movement plane, which is aligned transverse to a rotation axis (6) of the output shaft.

29. Stirling engine arrangement according to claim 28, wherein adjacent piston pairs lie with the working pistons or the displacement pistons adjacent to each other.

30. Stirling engine arrangement according to claim 16, wherein the working piston and the displacement piston are arranged in a common cylinder and controlled by different cam devices, which are arranged in movement planes arranged parallel to and spaced from the centre axis.
